(19) United States
(12) Patent Application Publication
(10) Pub. No.: US 2026/0321215 A1
(43) Pub. Date: Oct. 15, 2026

(54) TERMINAL DEVICE AND DISPLAY APPARATUS

(71) Applicants: Beijing BOE Display Technology Co., Ltd., Beijing (CN); BOE Technology Group Co., Ltd., Beijing (CN); Beijing BOE Technology Development Co., Ltd., Beijing (CN)

(72) Inventors: Peng LI, Beijing (CN); Rui GUO, Beijing (CN); Zhengyan WAN, Beijing (CN)

(21) Appl. No.: 19/484,540

(22) PCT Filed: May 31, 2024
(86) PCT No.: PCT/CN2024/096719

§ 371 Date: Nov. 14, 2025

(30) Foreign Application Priority Data
Jun. 5, 2023 (CN) 202321414639.5

(51) Int. Cl. G09G 3/34

(52) U.S. Cl. CPC G09G 3/3406; G09G 2310/08; G09G 2320/0233; G09G 2320/0276; G09G 2320/0666; G09G 2354/00

(57) ABSTRACT

Provided is a display apparatus. The display apparatus includes: a plurality of display panels, wherein each of the plurality of display panels includes a backlight module and a liquid crystal display module, wherein the liquid crystal display module includes a timing controller; and a control circuit, including a power supply circuit and a main control circuit, wherein the power supply circuit is connected to the backlight module of each of the plurality of display panels and is capable of being connected to an external power supply; the main control circuit is connected to the power supply circuit and is configured to control, through the power supply circuit, the backlight module to emit light; and the main control circuit is connected to the timing controller via a display interface and is configured to control a state of a liquid crystal of the liquid crystal display module.

### CROSS-REFERENCE TO RELATED APPLICATION

The present disclosure is a U.S. national stage of international application No. PCT/CN2024/096719, filed on May 31, 2024, which claims priority to Chinese Patent Application No. 202321414639.5, filed on Jun. 5, 2023 and entitled “TERMINAL DEVICE AND DISPLAY APPARATUS,” the disclosures of which are herein incorporated by references in their entireties.

### TECHNICAL FIELD

The present disclosure relates to the field of display technologies, and in particular, relates to a terminal device and a display apparatus.

### BACKGROUND

A display apparatus provided with a plurality of display panels has been widely used in education, business conferences, and other occasions. The display area is increased through the plurality of display panels, and various display effects are achieved. However, how to achieve the cooperative control of the plurality of display panels is an urgent problem to be solved.

### SUMMARY

The present disclosure provides a terminal device and a display apparatus.

According to some embodiments of the present disclosure, a display apparatus is provided. The display apparatus includes:
a plurality of display panels, wherein each of the plurality of display panels includes a backlight module and a liquid crystal display module, wherein the liquid crystal display module includes a timing controller; and
a control circuit, including a power supply circuit and a main control circuit that are disposed on a same main board, wherein the power supply circuit is connected to the backlight module of each of the plurality of display panels and is capable of being connected to an external power supply; the main control circuit is connected to the power supply circuit and is configured to control, through the power supply circuit, the backlight module to emit light; the main control circuit is connected to the timing controller of the liquid crystal display module via a display interface and is configured to control a state of a liquid crystal of the liquid crystal display module through a display signal transmitted through the display interface.

In some exemplary embodiments of the present disclosure, the power supply circuit includes:
a plurality of backlight circuits, wherein one of the plurality of backlight circuits is connected to the backlight module of one of the plurality of display panels, and the plurality of backlight circuits are connected to the main control circuit; and
a whole machine power supply, wherein the whole machine power supply is connected to the main control circuit and the plurality of backlight circuits, capable of being connected to the external power supply, and configured to supply power to the plurality of backlight circuits and the main control circuit; and
the main control circuit is configured to control, through each of the plurality of backlight circuits, the backlight module to emit light.

In some exemplary embodiments of the present disclosure, the main control circuit is connected to the whole machine power supply via a power control interface and a power interface, and the whole machine power supply supplies power to the main control circuit via the power interface; and
the whole machine power supply is connected to the plurality of backlight circuits via a backlight drive interface, the main control circuit transmits a backlight drive signal to the whole machine power supply via the power control interface, and the whole machine power supply controls, through the backlight drive signal received through the backlight drive interface, the backlight module to emit light.

In some exemplary embodiments of the present disclosure, the main control circuit is further configured to transmit a power control signal to the whole machine power supply via the power control interface, so as to control the whole machine power supply to perform power-on, standby, and power-off.

In some exemplary embodiments of the present disclosure, the power supply circuit includes:
a plurality of power sub-circuits, wherein one of the plurality of power sub-circuits is connected to the backlight module of one of the plurality of display panels, each of the plurality of power sub-circuits is capable of being connected to the external power supply and is connected to the main control circuit,
one of the plurality of power sub-circuits is configured to supply power to the main control circuit, and the main control circuit is configured to control, through each of the plurality of power sub-circuits, the backlight module to emit light.

In some exemplary embodiments of the present disclosure, each of the power sub-circuits includes a panel power supply and a backlight circuit; wherein
the panel power supply of each of the plurality of power sub-circuits is capable of being connected to the external power supply, the main control circuit is connected to the panel power supply of one of the plurality of power sub-circuits via a power interface, and the one of the plurality of power sub-circuits connected to the main control circuit is configured to supply power to the main control circuit; and
the main control circuit is connected to the backlight circuit via a backlight drive interface, and controls, through a backlight drive signal transmitted through the backlight drive interface, the backlight module to emit light.

In some exemplary embodiments of the present disclosure, the main control circuit is further configured to transmit, via at least part of backlight drive interfaces, a power control signal to power sub-circuits connected to the at least part of the backlight drive interfaces, so as to control the power sub-circuits to perform power-on, standby, and power-off.

In some exemplary embodiments of the present disclosure, the main control circuit includes:
an image processing circuit, configured to generate initial display information of the plurality of display panels; and
a buffer processing circuit, connected to the image processing circuit, and configured to correct the initial display information based on correction information to acquire target display information of each of the plurality of display panels, and generate the display signal for each of the plurality of display panels based on the target display information, wherein the correction information comprises at least one of luminance difference information, color temperature information, or gamma information.

In some exemplary embodiments of the present disclosure, the display interface is a DisplayPort (DP) interface.

In some exemplary embodiments of the present disclosure, the display apparatus further includes:
a touch apparatus, disposed on a light-emitting side of each of the plurality of display panels and configured to generate a touch signal based on a touch operation; and
a touch processing circuit, wherein the touch processing circuit is connected to the touch apparatus, capable of being connected to a host, and configured to generate a touch control signal based on the touch signal.

The main control circuit is connected to the touch processing circuit and the plurality of display panels, and is capable of being connected to the host; the control circuit is configured to control, based on a touch execution signal generated by the host based on the touch control signal, the plurality of display panels to display images, or control, based on the touch control signal, the plurality of display panels to display images.

In some exemplary embodiments of the present disclosure, the host is configured with a first system, and the control circuit is configured with a second system; and
the control circuit is configured to control, based on the touch execution signal generated by the host in the first system based on the touch control signal, the plurality of display panels to display the images, or control, based on the touch control signal, the plurality of display panels to display the images in the second system.

In some exemplary embodiments of the present disclosure, the plurality of display panels include secondary panels. The display apparatus further includes:
a panel control circuit, connected to one of the plurality of power sub-circuits and the liquid crystal display module of one of the secondary panels, and connected to the main control circuit, wherein the one of the plurality of power sub-circuits connected to the panel control circuit is configured to supply power to the panel control circuit.

The panel control circuit is configured to transmit a received display signal provided by the main control circuit or a received display signal provided by an external device to the liquid crystal display module of the one of the secondary panels, and replace the main control circuit to control, through the power sub-circuit, the backlight module of the one of the secondary panels to emit light.

In some exemplary embodiments of the present disclosure, the panel control circuit includes:
a selection circuit, wherein the selection circuit is connected to the main control circuit, capable of being connected to the external device, and configured to receive the display signal provided by the main control circuit and the display signal provided by the external device; and
a panel processing circuit, wherein the panel processing circuit is connected to the selection circuit, and configured to control the selection circuit to select one of the display signal provided by the main control circuit and the display signal provided by the external device to be transmitted to the liquid crystal display module of the one of the secondary panels.

In some exemplary embodiments of the present disclosure, three display panels are provided, and includes one main panel and two secondary panels, wherein a dimension of the one main panel is larger than a dimension of each of the two secondary panels, and the two secondary panels are symmetrically distributed on both sides of the one main panel.

In some exemplary embodiments of the present disclosure, the plurality of display panels are distributed along a same plane.

The touch apparatus includes a first infrared emission assembly and a first infrared reception assembly that are distributed in a first direction, and a second infrared emission assembly and a second infrared reception assembly that are distributed in a second direction, wherein the first infrared emission assembly is configured to emit infrared rays to the first infrared reception assembly, the second infrared emission assembly is configured to emit infrared rays to the second infrared reception assembly, and the first infrared reception assembly and the second infrared reception assembly generate the touch signal based on an effect of the touch operation on the infrared rays.

In some exemplary embodiments of the present disclosure, the backlight module includes a backlight drive circuit and a plurality of backlight zones, wherein one of the plurality of backlight zones is provided with a plurality of light-emitting devices; the backlight drive circuit comprises a plurality of backlight sub-circuits, wherein one of the plurality of backlight sub-circuits is connected to the plurality of light-emitting devices in one of the plurality of backlight zones, and the plurality of backlight sub-circuits are connected to the main control circuit via a backlight interface; and the main control circuit is configured to receive a backlight control signal transmitted by the timing controller via the display interface, and control, based on the backlight control signal, the plurality of backlight sub-circuits to enable the plurality of light-emitting devices of each of the plurality of backlight zones to emit light.

In some exemplary embodiments of the present disclosure, each of the plurality of display panels further comprises a photosensitive element, wherein the photosensitive element is connected to the timing controller, and is configured to detect luminance of light emitted from the display panel, transmit acquired luminance information to the timing controller, and transmit the luminance information to the main control circuit via the display interface; and

The main control circuit is further configured to control, based on the luminance information, the luminance of the light emitted from the display panel.

According to some embodiments of the present disclosure, a terminal device is provided. The terminal device includes:
the display apparatus according to any one of the above embodiments; and
a host, connected to the control circuit.

### BRIEF DESCRIPTION OF DRAWINGS

The accompanying drawings, which are incorporated into and constitute a part of the specification, illustrate embodiments consistent with the present disclosure and are used in conjunction with the specification to explain the principles of the present disclosure. Apparently, the accompanying drawings in the following description illustrate merely some embodiments of the present disclosure, and those of ordinary skill in the art may still derive other accompanying drawings from these accompanying drawings without creative efforts.

FIG. 1 is a schematic diagram of a display apparatus according to some embodiments of the present disclosure;

FIG. 2 is a schematic diagram of a terminal device according to some embodiments of the present disclosure;

FIG. 3 is a schematic diagram of a terminal device according to some embodiments of the present disclosure;

FIG. 4 is a schematic driving diagram of a secondary panel in a display apparatus according to some embodiments of the present disclosure;

FIG. 5 is a schematic diagram of a main control circuit in a display apparatus according to some embodiments of the present disclosure;

FIG. 6 is a schematic diagram of a display apparatus according to some embodiments of the present disclosure; and

FIG. 7 is a schematic diagram of a display apparatus according to the present disclosure.

### DETAILED DESCRIPTION

Exemplary embodiments will now be described more comprehensively with reference to the accompanying drawings. However, the exemplary embodiments may be implemented in various forms, and should not be understood as being limited to the embodiments described herein. On the contrary, these embodiments are provided to make the present disclosure comprehensive and complete, and comprehensively convey the idea of the exemplary embodiments to a person skilled in the art. The same reference numerals in the accompanying drawings indicate the same or similar structures, and thus, a detailed description thereof will be omitted. In addition, the accompanying drawings are only schematic illustrations of the present disclosure and are not necessarily drawn to scale.

The terms “one,” “a,” “the,” “said,” and “at least one” are used to indicate the presence of one or more elements/components, and the like. The terms “include,” “comprise,” and “provided with” are used to indicate open-ended inclusion and mean that additional elements/components, and the like may be present in addition to the listed elements/components, and the like. The terms “first,” “second,” “third,” or the like are used merely as labels, and are not intended to limit the number of objects thereof.

The display apparatus usually achieves image display and touch control in a plurality of modes, but the touch response speed varies significantly across different display modes.

It should be noted that the information disclosed in Background is only used for enhancement of understanding of the background of the present disclosure and therefore may include information that does not constitute the prior art known to those of ordinary skill in the art.

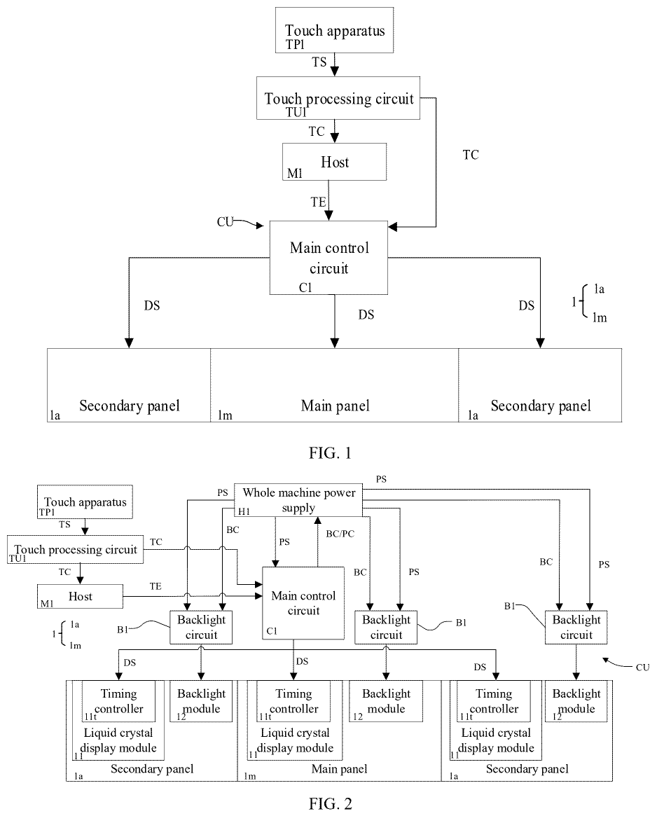

The embodiments of the present disclosure provide a display apparatus. As illustrated in FIG. 1, the display apparatus includes a display panel 1, a touch apparatus TP1, a touch processing circuit TU1, and a control circuit CU.

A plurality of display panels 1 are provided. The touch apparatus TP1 is disposed on the light-emitting side of each display panel 1, and configured to generate a touch signal TS based on a touch operation. The touch processing circuit TU1 is connected to the touch apparatus TP1, and is capable of being connected to a host M1. The touch processing circuit TU1 is configured to generate a touch control signal TC based on the touch signal TS.

The control circuit CU is connected to the touch processing circuit TU1 and each display panel 1, and is capable of being connected to the host M1. The control circuit CU is configured to control, based on a touch execution signal TE generated by the host M1 based on the touch control signal TC, the display panel 1 to display images, or control, based on the touch control signal TC, the display panel 1 to display images.

According to the display apparatus of the present disclosure, the touch signal TS is processed by the touch processing circuit TU1 to acquire the touch control signal TC, and then the touch control signal TC is transmitted to the host M1 and the control circuit CU. In a display mode, the host M1 generates the touch execution signal TE based on the touch control signal TC, and the control circuit CU controls, based on the touch execution signal TE, the display panel 1 to display the images. The control circuit CU determines, based on the host M1, that the control circuit CU directly controls, based on the touch control signal TC received by the control circuit CU, the display panel 1 to display the images in another display mode. In the two display modes, the host M1 and the control circuit CU do not need to perform the action of processing and converting the touch signal TS into the touch control signal TC, but the touch control circuit CU uniformly performs the action, such that the difference in the duration of processing the signals for achieving the touch function in the two display modes is reduced, and the consistency of the touch response speeds is improved.

The display apparatus of the present disclosure will be described in detail hereinafter.

As illustrated in FIG. 1, the display apparatus according to the present disclosure adopts a plurality of display panels 1, and two, three, or more display panels may be provided, which is not particularly limited herein. The display panels 1 may be distributed in a specified manner, for example, along a straight line, or along an annular track or other tracks. The arrangement manner thereof is not particularly limited herein. Meanwhile, the display panels 1 may be distributed along the same plane to form a flat substrate.

The shapes of different display panels 1 may be the same or different, and the dimensions of different display panels 1 may be the same or different. For example, the shape of each display panel 1 is rectangular, and the dimension of the display panel may refer to a length of a diagonal line, and may be 86 inches, 63 inches, or the like.

As illustrated in FIG. 1, in some embodiments of the present disclosure, three display panels 1 are provided, and includes one main panel 1m and two secondary panels 1a. The three display panels are distributed along a straight line, and the two secondary panels 1a are symmetrically distributed on both sides of the main panel 1m. The dimension of the main panel 1m is larger than the dimension of the secondary panel 1a. For example, the dimension of the main panel 1m is 86 inches, and the dimensions of the secondary panels 1a are equal to each other, that is, 63 inches.

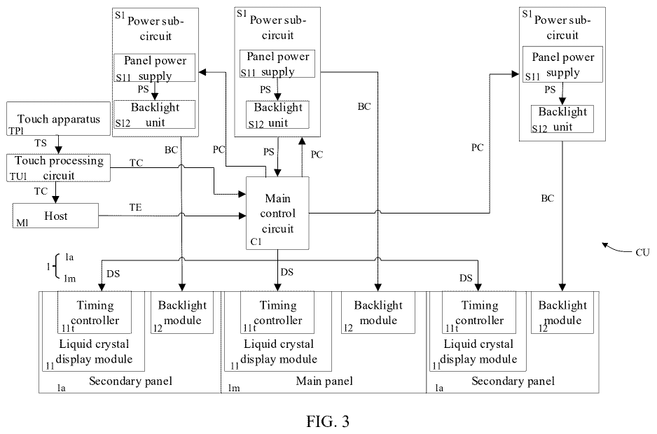

As illustrated in FIGS. 2 and 3, each display panel 1 may be a liquid crystal display panel, an organic light-emitting diode (OLED) display panel 1, or the like, as long as an image can be displayed, which is not particularly limited herein. Using an example of a liquid crystal display panel, the display panel 1 includes a liquid crystal display module 11 and a backlight module 12.

The liquid crystal display module 11 includes an array substrate and an opposed substrate that are arranged in an opposite manner, and a liquid crystal layer disposed between the array substrate and the opposed substrate. The backlight module 12 is disposed on a side of the array substrate facing away from the opposed substrate. The backlight module 12 serves as a light source to emit light to the array substrate, and the deflection state of the liquid crystal molecules are controlled by the drive circuit of the array substrate, so as to control the gray scale and achieve image display. The opposed substrate may be a color filter substrate, which may be provided with a plurality of color filters, and color display is achieved through the light-filtering effect of the color filters of different colors. Alternatively, the opposed substrate does not include a color filter, the backlight module 12 emits light of different colors, and color display is achieved in a field-sequential display manner.

In the case where the liquid crystal display panel displays the images, a signal for driving the drive circuit of the array substrate and a signal for driving the backlight module 12 are required. For example, the display panel 1 is provided with a display region and a peripheral region located outside the display region, and the liquid crystal display module 11 includes a plurality of rows and a plurality of columns of pixel circuits located in the display region, and a timing controller 11t, a gate drive circuit, and a source drive circuit that are located in the peripheral region.

The gate drive circuit scans each row of pixel circuits, such that the pixel circuits receive data signals. The source drive circuit inputs data signals to each column of pixel circuits to control the voltage of each pixel electrode through the pixel circuits to control the gray scale. The timing controller 11t is configured to control the gate drive circuit and the source drive circuit based on a display signal, thereby controlling the operation timing of the pixel circuit.

The backlight module 12 receives a backlight drive signal BC, and emits light under the control of the backlight drive signal BC. The backlight module 12 is controlled to be on or off based on the backlight drive signal BC, and the light emission luminance is further controlled based on the backlight drive signal BC. In addition, the backlight module 12 includes a plurality of backlight module 12 units 121, and different regions of the backlight module 12 are driven by the backlight module 12 units respectively.

As illustrated in FIGS. 2 and 3, the touch apparatus TP1 adopts an infrared touch structure, and further adopts other structures such as ultrasonic touch. Using as an example of the infrared touch structure, the touch apparatus TP1 includes a first infrared emission assembly and a first infrared reception assembly that are distributed in a first direction, and a second infrared emission assembly and a second infrared reception assembly that are distributed in a second direction. The first direction is intersected with the second direction each other. For example, the first direction is perpendicular to the second direction.

The first infrared emission assembly emits infrared rays to the first infrared reception assembly, and the second infrared emission assembly emits infrared rays to the second infrared reception assembly. In the case where a user performs a touch operation by using a touch part or a finger, a part of the infrared rays are blocked, such that the signals received by the first infrared reception assembly and the second infrared reception assembly are deformed, and thus the touch signal TS is generated by using the first infrared reception assembly and the second infrared reception assembly.

Further, the first infrared emission assembly includes a plurality of infrared light-emitting elements distributed in the second direction, and the first infrared reception assembly includes receiving elements in one-to-one correspondence with the infrared light-emitting elements of the first infrared emission assembly; and the second infrared emission assembly includes a plurality of infrared light-emitting elements distributed in the first direction, and the second infrared reception assembly includes receiving elements in one-to-one correspondence with the infrared light-emitting elements of the second infrared emission assembly.

Alternatively, the display panel 1 is a display panel provided with a touch electrode, and achieves touch control based on a capacitive or resistive structure. The touch electrode of each display panel 1 serves as the touch apparatus TP1, and each display panel 1 generates the touch signal TS. Since the plurality of display panels 1 are provided, the touch signal TS are processed by a pre-designed algorithm, and the position of the touch position in the entire display apparatus is acquired based on the touch signal TS of a single touch panel, such that the touch function is achieved.

Based on the above display panel 1, other parts of the display apparatus will be described in detail hereinafter.

As illustrated in FIGS. 1 to 3, each display panel 1 is connected to the control circuit CU, and displays the images under the control of the control circuit CU. The control circuit CU is further connected to an external host M1, and the display panel displays the images through the control circuit CU under the control of the host M1. Meanwhile, a specific image is displayed based on the touch signal TS sensed by the touch apparatus TP1. For example, a specific interface or icon is displayed in the image based on a touch operation.

The host M1 is configured with a first system, and the control circuit CU is configured with a second system. The two systems are different. For example, the first system is a Windows system, and the second system is an Android system.

In some embodiments of the present disclosure, the touch signal TS is transmitted to the host M1 and the control circuit CU, and the control circuit CU selects a display mode based on the selection operation of the user, that is, displaying based on the first system or the second system. During the selection operation, the first system or the second system may be running by default. That is, the control circuit CU selects whether to control the image display by itself or achieve the image display through a signal provided by the host M1.

Since the host M1 and the control circuit CU run different systems, the host and the control circuit have different processing methods for the touch signal TS and different time consumption. In addition, a solution of displaying the images through the host M1 still needs to use the control circuit CU, such that the touch response speed varies significantly across different display modes.

The present disclosure proposes the touch processing circuit TU1 to improve the problem. The touch apparatus TP1 is connected to the touch processing circuit TU1. For example, the first infrared reception assembly and the second infrared reception assembly are connected to the touch processing circuit TU1. The touch processing circuit TU1 may be a microcontroller unit (MCU) or other elements, which processes the touch signal TS to generate the touch control signal TC. Meanwhile, the touch processing circuit TU1 is further connected to the control circuit CU and the host M1, such that the touch control signal TC is transmitted to the host M1 and the control circuit CU. As a result, the host M1 and the control circuit CU do not need to perform the above processing action on the touch signal TS.

The control circuit CU directly controls, based on the touch control signal TC, the display panel 1 to display the images, and the host M1 converts the touch control signal TC into the touch execution signal TE and transmit the touch execution signal to the control circuit CU. The control circuit CU controls, based on the touch execution signal TE, the display panel 1 to display the images.

The control circuit CU selects a display mode by selecting a system based on the operation of the user. In the case where the first system is running in the foreground, and the second system is turned off or running in the background, the control circuit CU controls, based on the touch execution signal TE generated by the host M1, the display panel 1 to display the images. In the case where the second system is running in the foreground, and the first system is turned off or running in the background, the control circuit CU directly controls, based on the touch control signal TC, the display panel 1 to display the images.

As illustrated in FIGS. 2 and 3, in some embodiments of the present disclosure, the control circuit CU includes a power supply circuit and a main control circuit C1.

The power supply circuit is connected to the backlight module 12 of each display panel 1 and the power supply circuit is further connected to an external power supply. The external power supply serves as a total power supply of the entire display apparatus, which may be 220 V mains power or may be another apparatus capable of providing electric energy. The power supply circuit supplies power to the backlight module 12 of each display panel 1.

The main control circuit C1 is connected to the power supply circuit and the liquid crystal display module 11 of each display panel 1. The main control circuit C1 controls the state of the liquid crystal of the liquid crystal display module 11, and controls, through the power supply circuit, the backlight module 12 to emit light. The main control circuit C1 may be a system on chip (SOC) or other integrated circuits, and the specific structure of the main control circuit C1 is not particularly limited herein.

For example, the main control circuit C1 is connected to the timing controller 11t of each liquid crystal display module 11 via a display interface, and transmits a display signal DS via the display interface. The state of the liquid crystal of the liquid crystal display module 11 is controlled through the display signal DS, thereby achieving the control of the gray scale to display the images.

To acquire a good display effect, the color temperature, luminance, and other parameters of the display panel 1 may be corrected. Since it is difficult to achieve complete consistency in the manufacturing process, material, and other factors of different display panels 1, it is necessary to correct the display signal by using different correction information, and the correction information of different display panels 1 is different. However, this may cause differences in the final display effects of different display panels 1. For example, it is difficult to maintain consistency in color temperature, luminance, gamma correction, and the like, resulting in poor picture consistency of the plurality of display panels 1. Based on this, the display signals are corrected by using the same correction information to improve the consistency in the display effects of different display panels 1. As illustrated in FIG. 5, for example, the main control circuit C1 includes an image processing circuit C11 and a buffer processing circuit C12.

The image processing circuit C11 generates initial display information DSb for each display panel 1, which includes grayscale information.

The buffer processing circuit C12 is connected to the image processing circuit C11, and corrects the initial display information DSb based on correction information to acquire the target display information of each display panel 1. The correction information includes at least one of luminance difference information, color temperature information, or gamma information. Meanwhile, the correction information is determined based on the inherent attribute of one of the display panels 1. That is, the correction information of one display panel 1 serves as a reference to correct other display panels 1 without using the original correction information of the other display panels 1. Alternatively, the correction information is preset without using the correction information of any one of the display panels 1, and the target display information is generated based on the correction information.

Upon acquiring the target display information, the buffer processing circuit C12 generates the display signal DS for each display panel 1 based on the target display information, and transmits the display signal to the timing controller 11t of the display panel 1.

In addition, in the liquid crystal display module 11 of the display panel 1, a gamma correction circuit is further provided, and the gamma correction circuit performs gamma correction on the data signal output by the timing controller 11t, and then output the corrected data signal to the source drive circuit to control the gray scale of the picture.

In some embodiments of the present disclosure, to reduce the delay, the main control circuit C1 directly transmits the display signal to the timing controller 11t of the display panel 1 without transmitting the signal through other circuits. Therefore, the above display interface adopts a DP interface to transmit the display signal to the timing controller 11t. Further, the display interface is an embedded DisplayPort (eDP), thereby avoiding adoption of an interface such as a V-by-one (VBO) and reducing the delay.

Further, for the DP interface, a connecting line is designed by using an external DP cable rule for shielding processing, such that an anti-interference capability of a sensitive signal is effectively improved. In this way, separate interface and trace designs are reduced, costs is reduced, and internal control logic is optimized.

To solve the problem that the backlights of the plurality of display panels 1 are not synchronized, the present disclosure provides a plurality of solutions, which are illustrated hereinafter.

In some embodiments of the present disclosure, the power supply circuit includes a backlight circuit B1 and a whole machine power supply H1, and each backlight circuit B1 and the main control circuit C1 share one whole machine power supply H1. For example,
a plurality of backlight circuits B1 are provided, and one of the backlight circuits B1 is connected to the backlight module 12 of one display panel 1 to control the backlight module 12 to emit light. In the case where one backlight module 12 includes a plurality of backlight components, each backlight component is connected to one backlight circuit B1. Meanwhile, each backlight circuit B1 is connected to the main control circuit C1 to control, under the control of the main control circuit C1, each backlight module 12 to emit light.

The whole machine power supply H1 is connected to an external power supply to supply power to the entire display apparatus. For example, the whole machine power supply H1 is connected to the main control circuit C1 and each backlight circuit B1 to supply power to the main control circuit C1 and each backlight circuit B1.

Further, the main control circuit C1 is connected to the whole machine power supply H1 via a power control interface and a power interface separately. The whole machine power supply H1 supplies power to the main control circuit C1 via the power interface. Meanwhile, the overall power supply H1 is connected to the backlight circuits B1 via backlight drive interfaces, the main control circuit C1 transmits the backlight drive signal BC to the whole machine power supply H1 via the power control interface, and the whole machine power supply H1 forwards the backlight drive signal BC received through the backlight drive interface to each backlight module 12 to control the backlight module 12 to emit light. In the case where the main control circuit C1 controls the backlight module 12, the backlight drive signals BC are all forwarded by the whole machine power supply H1, which is beneficial to preventing the messy wiring. Alternatively, in some embodiments, the main control circuit C1 is directly connected to each backlight circuit B1 to directly transmit the backlight drive signal BC to the backlight circuit B1. Alternatively, the main control circuit C1 transmits the backlight drive signal BC via other interfaces, rather than via the power control interface.

In addition, in some embodiments, the main control circuit C1 transmits a power control signal PC to the whole machine power supply H1 via the power control interface, thereby controlling the whole machine power supply H1 to perform power-on, standby, and power-off.

The backlight circuit B1 may be integrated onto one board. In the case where the backlight circuit B1 includes a plurality of backlight components, one backlight component is integrated onto one board. The plurality of backlight circuits B1 are integrated onto a plurality of boards, and the main control circuit C1 is integrated onto one board. The whole machine power supply H1 is integrated onto the same board or element, and the boards and elements are disposed on the same main board. The interfaces are connected through traces on the main board, and the specific pattern is not particularly limited herein. The main control circuit C1 and the power supply circuit are disposed on the same main board, and the plurality of display panels display images under the control of the main control circuit C1 without separate and independent control.

In some embodiments of the present disclosure, the power supply circuit includes a plurality of power sub-circuits S1. One power sub-circuit S1 is connected to the backlight module 12 of one display panel 1, the power sub-circuits S1 are connected to the external power supply, and the external power supply supplies power to the backlight module 12 through the power sub-circuits S1. Each power sub-circuit S1 independently supplies power to the backlight module 12 of each display panel 1, and there is no shared whole machine power supply H1.

The power sub-circuits S1 are connected to the main control circuit C1, and one power sub-circuit S1 supplies power to the main control circuit C1.

The main control circuit C1 controls, through the power sub-circuits S1, the backlight modules 12 to emit light. That is, the power sub-circuit in the embodiments is not only a circuit for supplying power, but also features a backlight control function. For example, the power sub-circuit S1 includes a panel power supply S11 and a backlight unit S12.

The panel power supply S11 of each power sub-circuit S1 is capable of being connected to the external power supply, and the external power supply supplies power to each backlight module 12 through each power sub-circuit S1. For ease of connection, the display apparatus is provided with an external power interface, and the power sub-circuits S1 is connected to the external power supply through the external power interface, avoiding connection through different interfaces.

The main control circuit C1 is connected to the panel power supply S11 of one power sub-circuit S1 via a power interface, and is powered by the panel power supply S11 of the power sub-circuit S1. Meanwhile, the main control circuit C1 is connected to each backlight unit S12 via a backlight drive interface, and transmits the backlight drive signal BC to the backlight unit S12 via the backlight drive interface, thereby controlling, through the backlight drive signal BC, the backlight modules 12 to emit light. In the embodiments, the main control circuit C1 directly transmits the backlight drive signal BC to the backlight units S12 without forwarding the backlight drive signal BC through the whole machine power supply H1.

In addition, the main control circuit C1 further transmits, via at least part of the backlight drive interfaces, a power control signal PC to the power sub-circuits S1 connected to the main control circuit C1, so as to control the power sub-circuits S1 to perform power-on, standby, and power-off, thereby controlling the display panels 1. Alternatively, the power control signal PC is transmitted via other dedicated interfaces other than the backlight drive interface, and the interface is not particularly limited herein.

The power sub-circuit S1 is integrated onto one board, the plurality of power sub-circuits S1 are integrated onto a plurality of boards, and the main control circuit C1 is integrated onto one board. The boards are disposed on the same main board, and the external power interface is disposed on the main board. The interfaces are connected through traces on the main board, and the specific pattern is not particularly limited herein. The main control circuit C1 and the power supply circuit are disposed on the same main board, and the plurality of display panels display images under the control of the main control circuit C1 without separate and independent control.

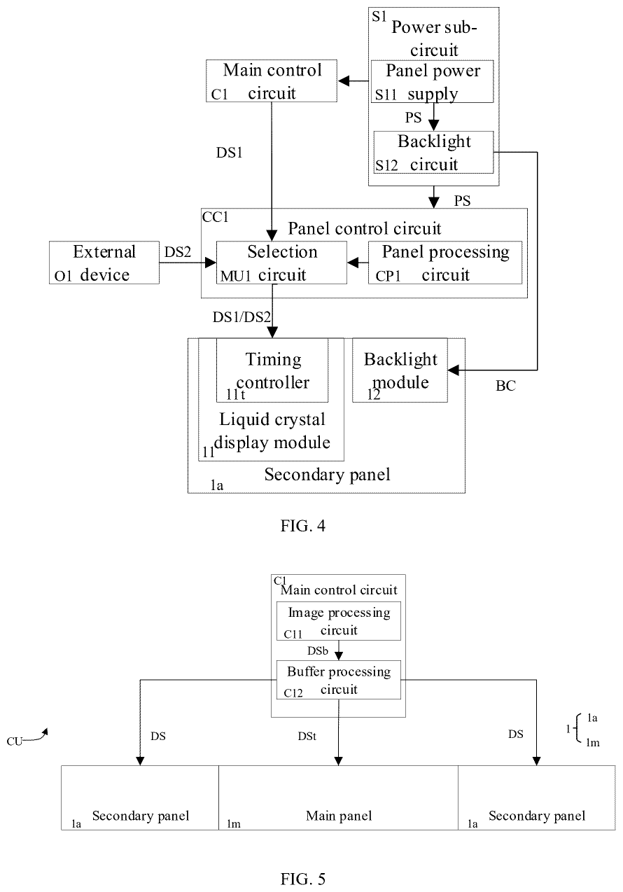

In FIGS. 2 to 4, the PS indicates a power supply path.

In some embodiments of the present disclosure, on the basis of displaying the images based on the host M1 and the control circuit CU, at least one display panel 1 further displays images based on other external devices O1. For example, one secondary panel 1a achieves external display.

The display apparatus further includes a panel control circuit CC1, and the panel control circuit CC1 is connected to the liquid crystal display module 11 of the secondary panel 1a, for example, connected to the timing controller 11t of the liquid crystal display module 11. The panel control circuit CC1 is connected to the power sub-circuit S1 connected to the backlight module 12 of the secondary panel 1a. The main control circuit C1 is connected to the panel control circuit CC1. The power sub-circuit S1 connected to the panel control circuit CC1 supplies power to the panel control circuit CC1. The main control circuit C1 is no longer connected to the power sub-circuit S1 connected to the backlight module 12 of the secondary panel 1a, such that the main control circuit C1 no longer controls the backlight module 12 of the secondary panel 1a to emit light, but the panel control circuit CC1 is used to replace the main control circuit C1 to control, through the power sub-circuit S1, the backlight module 12 of the secondary panel 1a to emit light.

The main control circuit C1 generates a display signal based on a touch operation or other information, and the display signal may be defined as a first display signal DS1. In addition, the external device O1 further provides a display signal, and the display signal may be defined as a second display signal DS2. The panel control circuit CC1 selects one of the first display signal DS1 and the second display signal DS2 and transmits it to the timing controller 11t of the liquid crystal display module 11 of the secondary panel 1a, such that the images are displayed based on the display signal. That is, the secondary panel 1a only displays the images based on one of the display signal provided by the main control circuit C1 and the display signal provided by the external device O1 at the same moment. Alternatively, in the case where the external device O1 is not connected, the second display signal DS2 does not exist, and the first display signal DS1 is transmitted to the timing controller 11t of the liquid crystal display module 11. After the external device O1 is connected, the first display signal DS1 and the second display signal DS2 are received simultaneously. Interactive controls such as menus and buttons are generated in the picture of the secondary panel 1a, and the user selects whether to display the images based on the first display signal DS1 or the second display signal DS2. Alternatively, a specific rule may also be set. For example, the second display signal DS2 is prioritized, and the second display signal DS2 is prioritized being transmitted to the liquid crystal display module 11 as long as the external device Ol is connected.

Further, in some embodiments, the panel control circuit CC1 includes a selection circuit MU1 and a panel processing circuit CP1.

The selection circuit MU1 is connected to the main control circuit C1, and is connected to the external device O1. The selection circuit MU1 receives the first display signal DS1 and the second display signal DS2. The selection circuit MU1 may be a multiplexer or other circuits or elements, as long as the selection of the first display signal DS1 and the second display signal DS2 are achieved. The selection herein refers to transmitting one of the first display signal DS1 and the second display signal DS2 to the timing controller 11t of the liquid crystal display module 11 of the secondary panel 1a.

Further, the selection circuit MU1 is connected to the main control circuit C1 via the display interface, the selection circuit MU1 is connected to an external display interface via the display interface, the external display interface is connected to an external device O1, and both the display interface and the external display interface may adopt a DP interface, for example, an eDP interface.

The panel processing circuit CP1 is connected to the selection circuit MU1, and controls the selection circuit MU1 to select one of the first display signal DS1 and the second display signal DS2 to be transmitted to the timing controller 11t of the liquid crystal display module 11 of the secondary panel 1a. The method for selecting one of the first display signal DS1 and the second display signal DS2 has been described above, and will not be described in detail herein. The panel processing circuit CP1 may adopt a single-chip microcomputer, or other elements and circuits, and the structure thereof is not particularly limited herein.

The selection circuit MU1 and the panel processing circuit CP1 may be integrated onto one board, or may adopt different boards, respectively, and the board and the main control circuit C1 may be disposed on the same main board.

In addition, the power lines connecting the external power supply and the whole machine power supply or the power sub-circuit, the power lines connecting the whole machine power supply and the backlight circuit, and the power lines connecting the power sub-circuit and the display panel are routed separately, and shielding measures are added to reduce interference between traces. For example, the main control circuit C1 and the timing controller 11t are connected to the eDP interface through a connector and traces, a conductive adhesive tape is attached to the front surface of the traces to reduce spatial electromagnetic interference, and the back surface of the connector is not wired and is grounded by copper plating.

Compared with a VBO interface that features only an image signal transmission function, the eDP interface transmits signals in a plurality of forms, for example, an image signal, a backlight control signal, and a photosensitive signal, thereby eliminating the need for separate wiring, and correspondingly, the need to shield the traces for different signals. As a result, the signal stability is improved, and the interface resources of the main control circuit C1 are saved.

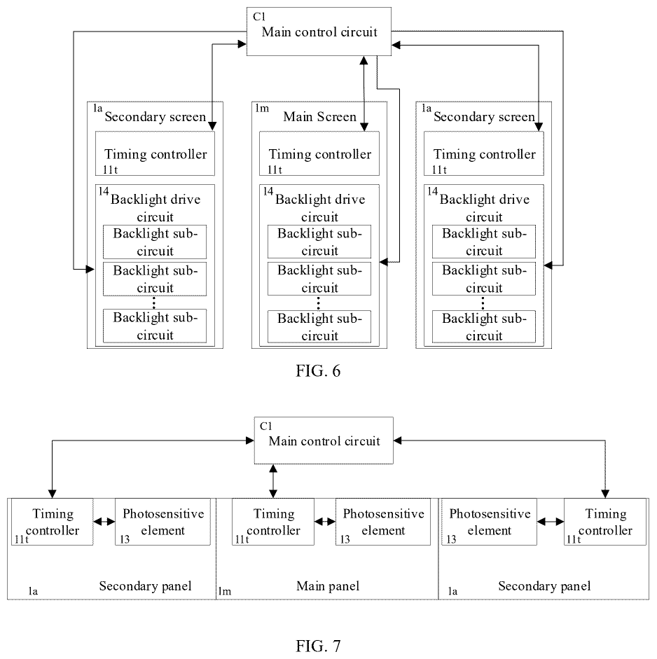

As illustrated in FIG. 6, in some embodiments of the present disclosure, the backlight module of each display panel includes a backlight drive circuit and a plurality of backlight zones, and one backlight zone is provided with a plurality of light-emitting devices.

The backlight drive circuit 13 includes a plurality of backlight sub-circuits, and one backlight sub-circuit is connected to the light-emitting devices in one backlight zone. Each backlight sub-circuit is connected to the main control circuit C1 via a backlight interface. For example, the backlight interface transmits data through an SPI protocol.

For a display panel, the main control circuit C1 transmits the received or generated initial display data to the timing controller 11t via the display interface, and the timing controller 11t acquires a pixel control signal and a backlight control signal based on the initial display data. The deflection state of the liquid crystal of the liquid crystal display module 11 is controlled through the pixel control signal. Meanwhile, the backlight control signal is transmitted to the backlight sub-circuits of each backlight drive circuit 13 via the backlight interface, and the backlight sub-circuit controls, based on the received backlight control signal, the light-emitting devices of each backlight zone to emit light.

In the above process, since the main control circuit C1 is directly connected to the timing controller 11t via the display interface, and the display interface may be a DP interface, and further, may be an eDP interface, the pixel control signal is transmitted by an extended display identification data (EDID) method, such that the signal transmission between the timing controller 11t and the main control circuit C1 is avoided, and the synchronization of the transmission of the initial display data and the backlight control signal is improved. For the eDP interface, the backlight control signal is transmitted to the main control circuit C1 through the AUX channel thereof. Since a plurality of backlight sub-circuits are provided, in the case where part of the backlight control signals transmitted to the backlight sub-circuits are defective, avoidance processing is performed to avoid affecting the use.

Further, the timing controller marks the backlight control signals outputted by the timing controller, the main control circuit C1 outputs the backlight control signals to corresponding backlight sub-circuits based on the marks, and the backlight sub-circuits identifies the marks of the received backlight control signals and controls the light emission of the backlight zones connected thereto based on the identification results.

As illustrated in FIG. 7, in some embodiments of the present disclosure, the display panel further includes a photosensitive element 14, and the photosensitive element 14 is connected to the timing controller 11t. The photosensitive element 14 includes a photoelectric sensor, configured to detect the luminance of light emitted from the display panel. Meanwhile, the photosensitive element 14 transmits the detected luminance information to the timing controller 11t, and the timing controller 11t transmits the information to the main control circuit 1C through a display interface. The display interface may be a DP interface, and further, may be an eDP interface. Each display panel is provided with a photosensitive element 14, and whether the photosensitive element 14 reads data is controlled by the timing controller 11t. The timing controller 11t converts the luminance information T into a signal conforming to a separately set transmission protocol rule, and the main control circuit C1 parses the control signal based on a corresponding protocol, such that the control signal and the pixel control signal transmitted through the display interface are transmitted through different transmission protocols, and different signals are distinguished. The main control circuit C1 compares the read luminance information with the initial luminance determined based on the initial display data; in the case where the detected luminance is lower than the initial luminance, the luminance of the backlight module 12 is adjusted based on different reduction proportions to compensate for the luminance reduction. In addition, the liquid crystal deflection degree of the liquid crystal display module 11 is further controlled, as long as the final luminance of the light emitted from the display panel is improved.

In the above process, the main control circuit C1 is directly connected to the timing controller 11t through the eDP interface, and the detected luminance information is directly transmitted to the main control circuit C1 through the timing controller 11t without transmitting through the timing controller 11t and the main control circuit C1, which may improve the synchronization of the backlight control of each display panel.

Based on the above display apparatus, the present disclosure further provides a control method. The control method includes S110 to S130.

In S110, initial display information of each display panel is generated.

In S120, the initial display information is corrected based on correction information to acquire target display information of each display panel, where the correction information includes at least one of luminance difference information, color temperature information, or gamma information.

In S130, display panels are controlled to display images based on the target display information.

The details of the steps of the above control method have been described in detail in the above embodiments of the display apparatus, which will not be repeated herein.

It should be noted that although the processes of the control method in the present disclosure are described in a specific order in the accompanying drawings, this does not require or imply that these processes are necessarily performed in this specific order, or that all of the illustrated processes are necessarily performed to achieve the desired results. Additionally or alternatively, some processes may be omitted, a plurality of processes may be combined into one process for execution, and/or one process may be divided into a plurality of processes for execution, among other variations.

The embodiments of the present disclosure further provide a terminal device. The terminal device includes a host and the display apparatus according to any one of the above embodiments.

The host is connected to the control circuit. For example, the host is connected to the main control circuit. In addition, the host may be an open pluggable specification (OPS) computer, or may be a tablet computer or another electronic device with data processing and image control functions, which will not be listed one by one herein. For the specific contents and beneficial effects of the display apparatus, reference may be made to the embodiments of the display apparatus, which will not be repeated herein.

The terminal device according to the present disclosure may be an electronic blackboard, a conference machine, or a device with an image display function, such as a television.

According to the terminal device and the display apparatus of the present disclosure, the power supply circuit and the main control circuit are integrated onto a main board, and the main control circuit controls the state of the liquid crystal of the liquid crystal module via the display interface and controls, through the power supply circuit, the backlight module to emit light. That is, the plurality of display panels display images under the control of the main control circuit without separate and independent control. Meanwhile, the power supply circuit is connected to the external power supply to supply power to the display panels uniformly, without supplying power separately.

It should be understood that both the foregoing general description and the following detailed description are exemplary and explanatory only and are not construed as limiting the present disclosure.

Other embodiments of the present disclosure are apparent to those skilled in the art from consideration of the specification and practices of the present disclosure disclosed herein. The present disclosure is intended to cover any variations, uses, or adaptations of the present disclosure following the general principles of the present disclosure and including known common knowledge or customary technical means in the art undisclosed in the present disclosure. The specification and embodiments are only exemplary, and the true scope and spirit of the present disclosure are indicated in the appended claims.

1. A display apparatus, comprising:
a plurality of display panels, wherein each of the plurality of display panels comprises a backlight module and a liquid crystal display module, wherein the liquid crystal display module comprises a timing controller; and
a control circuit, comprising a power supply circuit and a main control circuit that are disposed on a same main board, wherein the power supply circuit is connected to the backlight module of each of the plurality of display panels and is capable of being connected to an external power supply; the main control circuit is connected to the power supply circuit and is configured to control, through the power supply circuit, the backlight module to emit light; and the main control circuit is connected to the timing controller of the liquid crystal display module via a display interface and is configured to control a state of a liquid crystal of the liquid crystal display module through a display signal transmitted through the display interface.

2. The display apparatus according to claim 1, wherein
the power supply circuit comprises:
a plurality of backlight circuits, wherein one of the plurality of backlight circuits is connected to the backlight module of one of the plurality of display panels, and the plurality of backlight circuits are connected to the main control circuit; and
a whole machine power supply, wherein the whole machine power supply is connected to the main control circuit and the plurality of backlight circuits, capable of being connected to the external power supply, and configured to supply power to the plurality of backlight circuits and the main control circuit; and
the main control circuit is configured to control, through each of the plurality of backlight circuits, the backlight module to emit light.

3. The display apparatus according to claim 2, wherein
the main control circuit is connected to the whole machine power supply via a power control interface and a power interface, and the whole machine power supply supplies power to the main control circuit via the power interface; and
the whole machine power supply is connected to the plurality of backlight circuits via a backlight drive interface, the main control circuit transmits a backlight drive signal to the whole machine power supply via the power control interface, and the whole machine power supply controls, through the backlight drive signal received through the backlight drive interface, the backlight module to emit light.

4. The display apparatus according to claim 3, wherein the main control circuit is further configured to transmit a power control signal to the whole machine power supply via the power control interface, so as to control the whole machine power supply to perform power-on, standby, and power-off.

5. The display apparatus according to claim 1, wherein the power supply circuit comprises:
a plurality of power sub-circuits, wherein one of the plurality of power sub-circuits is connected to the backlight module of one of the plurality of display panels, each of the plurality of power sub-circuits is capable of being connected to the external power supply and is connected to the main control circuit, one of the plurality of power sub-circuits is configured to supply power to the main control circuit, and the main control circuit is configured to control, through each of the plurality of power sub-circuits, the backlight module to emit light.

6. The display apparatus according to claim 5, wherein each of the power sub-circuits comprises a panel power supply and a backlight circuit; wherein
the panel power supply of each of the plurality of power sub-circuits is capable of being connected to the external power supply, the main control circuit is connected to the panel power supply of one of the plurality of power sub-circuits via a power interface, and the one of the plurality of power sub-circuits connected to the main control circuit is configured to supply power to the main control circuit; and
the main control circuit is connected to the backlight circuit via a backlight drive interface, and controls, through a backlight drive signal transmitted through the backlight drive interface, the backlight module to emit light.

7. The display apparatus according to claim 6, wherein the main control circuit is further configured to transmit, via at least part of backlight drive interfaces, a power control signal to power sub-circuits connected to the at least part of the backlight drive interfaces, so as to control the power sub-circuits to perform power-on, standby, and power-off.

8. The display apparatus according to claim 1, wherein the main control circuit comprises:
an image processing circuit, configured to generate initial display information of the plurality of display panels; and
a buffer processing circuit, connected to the image processing circuit, and configured to correct the initial display information based on correction information to acquire target display information of each of the plurality of display panels, and generate the display signal for each of the plurality of display panels based on the target display information, wherein the correction information comprises at least one of luminance difference information, color temperature information, or gamma information.

9. The display apparatus according to claim 1, wherein the display interface is a DisplayPort (DP) interface.

10. The display apparatus according to claim 1, further comprising:
a touch apparatus, disposed on a light-emitting side of each of the plurality of display panels and configured to generate a touch signal based on a touch operation; and
a touch processing circuit, wherein the touch processing circuit is connected to the touch apparatus, capable of being connected to a host, and configured to generate a touch control signal based on the touch signal; and
the main control circuit is connected to the touch processing circuit and the plurality of display panels, and is capable of being connected to the host; and the control circuit is configured to control, based on a touch execution signal generated by the host based on the touch control signal, the plurality of display panels to display images, or control, based on the touch control signal, the plurality of display panels to display images.

11. The display apparatus according to claim 10, wherein the host is configured with a first system, and the control circuit is configured with a second system; and
the control circuit is configured to control, based on the touch execution signal generated by the host in the first system based on the touch control signal, the plurality of display panels to display the images, or control, based on the touch control signal, the plurality of display panels to display the images in the second system.

12. The display apparatus according to claim 5, wherein the plurality of display panels comprise secondary panels, and the display apparatus further comprises:
a panel control circuit, connected to one of the plurality of power sub-circuits and the liquid crystal display module of one of the secondary panels, and connected to the main control circuit, wherein the one of the plurality of power sub-circuits connected to the panel control circuit is configured to supply power to the panel control circuit; and
the panel control circuit is configured to transmit a received display signal provided by the main control circuit or a received display signal provided by an external device to the liquid crystal display module of the one of the secondary panels, and replace the main control circuit to control, through the power sub-circuit, the backlight module of the one of the secondary panels to emit light.

13. The display apparatus according to claim 12, wherein the panel control circuit comprises:
a selection circuit, wherein the selection circuit is connected to the main control circuit, capable of being connected to the external device, and configured to receive the display signal provided by the main control circuit and the display signal provided by the external device; and
a panel processing circuit, wherein the panel processing circuit is connected to the selection circuit, and configured to control the selection circuit to select one of the display signal provided by the main control circuit and the display signal provided by the external device to be transmitted to the liquid crystal display module of the one of the secondary panels.

14. The display apparatus according to claim 1, wherein three display panels are provided, and comprise one main panel and two secondary panels; wherein a dimension of the one main panel is larger than a dimension of each of the two secondary panels, and the two secondary panels are symmetrically distributed on both sides of the one main panel.

15. The display apparatus according to claim 11, wherein the plurality of display panels are distributed along a same plane; and
the touch apparatus comprises a first infrared emission assembly and a first infrared reception assembly that are distributed in a first direction, and a second infrared emission assembly and a second infrared reception assembly that are distributed in a second direction, wherein the first infrared emission assembly is configured to emit infrared rays to the first infrared reception assembly, the second infrared emission assembly is configured to emit infrared rays to the second infrared reception assembly, and the first infrared reception assembly and the second infrared reception assembly generate the touch signal based on an effect of the touch operation on the infrared rays.

16. The display apparatus according to claim 9, wherein the backlight module comprises a backlight drive circuit and a plurality of backlight zones, wherein one of the plurality of backlight zones is provided with a plurality of light-emitting devices; the backlight drive circuit comprises a plurality of backlight sub-circuits, wherein one of the plurality of backlight sub-circuits is connected to the plurality of light-emitting devices in one of the plurality of backlight zones, and the plurality of backlight sub-circuits are connected to the main control circuit via a backlight interface; and the main control circuit is configured to receive a backlight control signal transmitted by the timing controller via the display interface, and control, based on the backlight control signal, the plurality of backlight sub-circuits to enable the plurality of light-emitting devices of each of the plurality of backlight zones to emit light.

17. The display apparatus according to claim 9, wherein each of the plurality of display panels further comprises a photosensitive element, wherein the photosensitive element is connected to the timing controller, and is configured to detect luminance of light emitted from the display panel, transmit acquired luminance information to the timing controller, and transmit the luminance information to the main control circuit via the display interface; and
the main control circuit is further configured to control, based on the luminance information, the luminance of the light emitted from the display panel.

18. A terminal device, comprising:
a display apparatus, wherein the display apparatus comprises a plurality of display panels, wherein each of the plurality of display panels comprises a backlight module and a liquid crystal display module, wherein the liquid crystal display module comprises a timing controller; and a control circuit, comprising a power supply circuit and a main control circuit that are disposed on a same main board, wherein the power supply circuit is connected to the backlight module of each of the plurality of display panels and is capable of being connected to an external power supply; the main control circuit is connected to the power supply circuit and is configured to control, through the power supply circuit, the backlight module to emit light; and the main control circuit is connected to the timing controller of the liquid crystal display module via a display interface and is configured to control a state of a liquid crystal of the liquid crystal display module through a display signal transmitted through the display interface; and
a host, connected to the control circuit.

19. The terminal device according to claim 18, wherein
the power supply circuit comprises:
a plurality of backlight circuits, wherein one of the plurality of backlight circuits is connected to the backlight module of one of the plurality of display panels, and the plurality of backlight circuits are connected to the main control circuit; and
a whole machine power supply, wherein the whole machine power supply is connected to the main control circuit and the plurality of backlight circuits, capable of being connected to the external power supply, and configured to supply power to the plurality of backlight circuits and the main control circuit; and
the main control circuit is configured to control, through each of the plurality of backlight circuits, the backlight module to emit light.

20. The terminal device according to claim 19, wherein
the main control circuit is connected to the whole machine power supply via a power control interface and a power interface, and the whole machine power supply supplies power to the main control circuit via the power interface; and
the whole machine power supply is connected to the plurality of backlight circuits via a backlight drive interface, the main control circuit transmits a backlight drive signal to the whole machine power supply via the power control interface, and the whole machine power supply controls, through the backlight drive signal received through the backlight drive interface, the backlight module to emit light.
